(19) United States
(12) Patent Application Publication
(10) Pub. No.: US 2007/0193872 A1
(43) Pub. Date: Aug. 23, 2007

(54) Integrated solar liquid heater, distiller and pasteurizer system

(75) Inventors: Eduardo Garcia, Adjuntas, PR (US); George Vaida, San Juan, PR (US)

Correspondence Address: EZRA SUTTON, P.A.;Plaza 9 Building, 900 Route 9 North, Woodbridge, NJ, 07095, US

(73) Assignee: Technosun Puerto Rico

(21) Appl. No.: 11/358,963

(22) Filed: Feb. 22, 2006

(51) Int. Cl. B01D 3/42

(52) U.S. Cl. 202/234; 202/181; 202/197; 202/185.5; 202/185.6; 202/205; 202/267.1

(57) ABSTRACT

The solar heating, distilling, and pasteurizing system of this invention comprises an integrated distillation column-reflector-bracket assembly, a heat storage system of composite construction, and at least one evacuated glass solar collector having selective absorption. The distillation column subassembly is filled with the fluid medium to be boiled which flows into the solar vacuum tube collectors where an evaporation process takes place. A float valve mechanism mounted to the frame automatically maintains the correct liquid level inside the distillation column. The height of float valve mechanism is adjustable by means of an adjustable float bracket. The distillation column subassembly collects and concentrates the steam or vapor generated inside the attached evacuated glass solar collector tubes. The column also separates the vapor from the boiling liquid medium and conducts the vapor into a heat and distilled fluid storage system. The reflector-bracket subassembly has a reflecting panel made from at least one sheet of reflective material typically flat or formed into a plurality of substantially parallel linear troughs shaped to concentrate solar radiation ideally. This reflector also acts as a means of further stress and strain distribution and dissipation into the structural elements of the bracket subassembly.

### FIELD OF THE INVENTION

The present invention relates to a combined and integrated solar heating and solar distilling system. More particularly, to a modular and integral solar heating and distilling system which uses a composite heat storage system, a distillation column, all glass evacuated glass solar collector, a water feed and level control system, and a reflector-support bracket.

### BACKGROUND OF THE INVENTION

Solar water heating systems are well established in the art and numerous designs for solar thermal systems have appeared over the years in patents and in the published literature. The so-called water thermosyphon may well be the prevalent passive solar water heating system in terms of worldwide usage.

Most of these designs apparently operate properly, although some are more highly preferred by virtue of lower cost, greater durability, and/or higher efficiency. A major problem has been the extended cost of this energy relative to the cost from other sources. Corrosion and fouling substantially increase equipment maintenance and operational cost while reducing efficiency and durability of these designs. Another problem has been the inability of most of these systems to operate at sufficiently elevated efficiencies and temperatures, or under conditions of low ambient temperatures and/or low solar radiation. Another problem has been the lack of an energy efficient functional integration between water heating and distilling apparatus that could lower cost by offering multiple functions and configurations.

Solar water distiller systems are well established in the art and numerous designs for solar thermal systems have appeared over the years in patents and in the published literature. The so-called basin type may well be the prevalent passive solar still.

There remains a need for an integrated and combined solar liquid heater, distiller and pasteurization system that can operate in various modes with minor setting changes. Further, this system would include a distillation column assembly having a distillation column subassembly, a reflector subassembly, and a bracket subassembly. Additionally, the system would also have a condenser assembly, a plurality of glass solar vacuum collectors detachably connected to the distillation column subassembly and a float valve device also being detachably connected to the distillation column subassembly.

### DESCRIPTION OF THE PRIOR ART

Solar heating systems, solar distillation systems and pasteurization systems having various accessories, designs, configurations and materials of construction have been generally disclosed in the prior art. For example, U.S. Pat. No. 4,505,261 issued Mar. 15, 1985, discloses a modular solar energy storage system that comprises a plurality of heat pipes which are arranged to form a flat plate collector and are releasably connected to a water reservoir by, and are part of, double walled heat exchangers which penetrate to the water reservoir and enhance the heat transfer characteristics between the collector and the reservoir. The evaporative end of each heat pipe receives heat from solar radiation and transfers it directly to the condensing end of the heat pipes. The condensing end of each metal heat pipe is in good thermal contact with the heat storage tank.

The above-described heat pipe imparts several advantages to passive solar water heating systems. The heat pipe has excellent thermal conductance in that it has very high heat transfer capability over even a relatively small temperature gradient. Additionally, the evaporation-condensation cycle provides highly anisotropic, essentially one-way heat transfer along the pipe. It may help understanding to consider the situation at night or during other periods of low incident solar radiation. At such times, there is little or no evaporation and condensation of the working fluid; the fluid in its liquid or solid state pools or solidifies at the lower, concentrator end of the heat pipe. The resulting discontinuity in the conduction path between the absorber/concentrator and the tank essentially eliminates heat loss via the working fluid. The combined result of the excellent thermal conductance characteristics and evacuated solar collector concept in such embodiments so as to minimize maintenance and operational extended costs due to corrosion and fouling. Further, the prior art solar systems are less efficient and have a high cost relative to the integrated solar system presented here, either by lacking certain design features which are important for efficient solar systems, or by lacking design or production features needed to achieve low cost, or both of these reasons. The important features required to obtain high efficiency and low cost are the use of low cost corrosion and fouling resistant materials and processes for fabrication, selective absorption, vacuum, approximate ideal concentration, phase change heat pipe, and structural and functional integrity, not just of the collector, but of a combined collector, distillation column, reservoir, reflector and support bracket, embodied in such a way so that the design is modular and easy to disassemble. Functional integrity here means using one element or component to serve more than one function, thus simplifying the design and generally reducing cost. Structural integrity here means when all structural elements share and help to bear the mechanical loads imposed to the system as a whole, thus allowing the use of less amounts of corrosion resistant materials that otherwise would be too expensive to use.

In the prior art, the system of U.S. Pat. No. 4,505,261 is not designed to take advantage of evacuated solar collectors and the relatively high efficiency associated with them. This system fails to take full advantage of the potential of the heat pipe concept. In particular, the integrated solar thermal energy collector exemplified in this patent utilizes a relatively complex heat pipe/reservoir fabrication that is difficult or impossible to disassemble for inspection, maintenance or repair, leading to a substantial increase in operational and/or the one-way heat transfer characteristics is very efficient heat transfer along the heat pipe into the reservoir with little outward heat loss. Other advantages of adapting heat pipes to passive solar collectors, not exhaustive, include relatively light weight; adaptability to freeze protection, since only the reservoir tank contains water; increased resistance to fouling, since water does not flow through narrow-cross section pipes in the collector; and a high percentage net usable system energy, since little or no parasitic power consumption is required to operate the system. Substantial advantage in simplicity, and ease of maintenance is achieved by a modular design that can be easily disassembled. However, the above-described system does not use evacuated (vacuum) glass tubes for increased efficiency. Therefore, it is not suited for sustaining the high temperatures desired for pasteurization and distillation processes. While substantially improving modularity and functional integration, the system does not use a composite construction in the water reservoir, and mounts the flat plate solar collector directly to the essentially rigid water tank. Therefore, this design uses the potential for structural and functional integration in a very limited way.

U.S. Pat. No. 4,686,961, issued on Aug. 18, 1987, teaches an integrated solar thermal energy collector system consisting of an evacuated (vacuum) glass solar collector, a heat storage system, and a tubular heat pipe system to transfer heat from the evacuated glass solar collector directly to the heat source system. A substantial advantage in increased efficiency is achieved by this integration. However, this design lacks adequate structural integrity.

Despite the above substantial advantages over other prior art, heretofore it has not been possible to fully utilize the potential of the integrated reservoir, heat pipe, and the extended costs.

None of the above-described designs use corrosion and/or fouling mitigating measures in the reservoir. Despite achieving a higher level of functional integration relative to prior art, the above designs still lack the high level of functional and structural integration that allow the economical use of more exotic materials such as, but not limited to, stainless steels or special temperature resistant glass. In short, while incorporation of the heat pipe and evacuated collector technology into integrated and/or modular solar heating systems represent an advance in passive solar energy technology, the potential of such integration for combined simplicity, durability, ease of maintenance, efficiency, and low initial and extended cost has not been fully realized.

U.S. Pat. No. 5,628,879, issued on May 13, 1997, teaches the history of the development of solar distillation and thoroughly references and describes the attempts that have been made in order to improve the efficiency and reduce the cost of solar stills. The inherent design problems of many types of solar stills are described. Of the many different types of solar stills which have been built and tested during the past 50 years, two types, basin stills and tilted stills, are considered to be the most practical for everyday use. However, basin stills and tilted still designs have been plagued by multiple deficiencies. Basin and tilted stills produce efficiently during the summer months but inefficiently during the winter months. This is because basin stills are very susceptible to heat loss into a low temperature environment and to the shallow incidence angle of solar radiation at that time of the year.

Another major problem of basin and tilted stills is the accumulation of evaporative salt deposits and algae growth. These salts diminish the still efficiency and algae growth will contaminate the distilled water and promote bacteria growth. The accumulation of evaporative salts and algae growth has to be periodically flushed or scrubbed, requiring substantial maintenance efforts and costs.

Another major problem of basin and tilted stills is the insulation techniques implemented by previous art. The stills require thermal insulation on the floor and the flour walls of the evaporative chamber in order to conserve heat internally and, in the prior art, insulation of the chamber has commonly been accomplished by building a double walled “box” and installing the insulation between the walls. The method of insulation is inferior to that insulation provided by air evacuation or partial vacuum inside insulating volumes. Because of their geometry, it is very difficult to implement vacuum insulation techniques in basin and tilted still designs. As a result, most basin and tilted stills operate at temperatures that could be well below the pasteurization temperatures required to avoid bacterial growth in distillate.

Because basin stills and tilted stills have to be periodically opened for flushing and cleaning, another major problem of basin and tilted stills is the difficulty to effectively seal the linear surfaces where the undersurface of the transparent still cover contacts the planar top surfaces of the walls enclosing the evaporation chamber. The difficulties will decrease the distilling efficiency and will promote vapor leaks, low temperatures, distillate contamination, bacterial growth and high manufacturing costs.

Another important prior art is the tilted wick still. In the practice of the prior art, fabrics of fibrous materials, either natural fibers, or synthetic fibers, have been used for wick matting in tilted wick stills. Major problems of the wick matting include: (1) Absorptive capacity is inadequate. (2) The original black color of the fabric fades under the impact of ultraviolet rays to a light color which reflects solar energy rather than absorbing it. (3) The distillate absorb an odor characteristic of the material in the wick matting, and this odor is identifiable as a taste in the distillate.

Another important feature of prior art is the multiple effect still. Multiple effect solar stills are more efficient and productive, they are also more complicated and costly to construct and extra work is required to keep them clean and in adjustment. Prior art has not been able to implement cost effective multiple effect techniques into solar stills. As a result, the multiple effect solar still is not considered to be the most practical for everyday use.

The proposed solar distiller improvements described in U.S. Pat. No. 4,686,961 and most of those proposed by other prior art do not utilize the benefits of the all glass vacuum tube collectors, operating at low temperatures and low efficiencies. The distiller improvements have failed to reach the market because of increased manufacturing and operating costs associated to the increased mechanical complexity of the designs.

None of the solar stills described in the prior art can efficiently provide simultaneous water heating, distilling, and pasteurizing for a typical domestic application. Despite achieving a higher level of efficiency relative to prior art, the above designs still lack a high level of functional and structural integration that allows the economical use of more exotic materials such as, but not limited to, stainless steels or special temperature resistant glass.

In short, while incorporation of the heat pipe and evacuated collector technology into integrated and/or modular solar heating and distilling systems represent an advance in passive solar energy technology, the potential of such functional and structural integration for combined simplicity, durability, ease of maintenance, efficiency, and low initial and extended cost has not been fully realized.

### OBJECTS OF THE PRESENT INVENTION

Accordingly, several objects and advantages of my invention are durability, low cost, low maintenance, high efficiency, operation at high temperatures, compactness, self cleaning, modularity, collapsibility, versatility and multi-functionality, resistance to corrosion, fouling and hurricanes. A novel implementation of solar vacuum tube collector, a multiple effect heat storage system and a distillation column achieves a major advantage of my design. The advantage is its capacity to simultaneously heat, distill, and pasteurize water or any other liquid medium without major equipment reconfiguration and by equipment that can be delivered in kit form and mass produced at low manufacturing costs.

### SUMMARY OF THE INVENTION

The solar heating, distilling, and pasteurizing system of this invention comprises an integrated distillation column-reflector-bracket assembly, a heat storage system of composite construction, and at least one evacuated glass solar collector having selective absorption.

A principal part of this invention is a distillation column-reflector-bracket assembly. The distillation column subassembly is filled with the fluid medium to be boiled which flows into the solar vacuum tube collectors where an evaporation process takes place. A float valve mechanism mounted to the frame automatically maintains the correct liquid level inside the distillation column. The height of float valve mechanism is adjustable by means of an adjustable float bracket. The distillation column subassembly collects and concentrates the steam or vapor generated inside the attached evacuated glass solar collector tubes. The column also separates the vapor from the boiling liquid medium and conducts the vapor into a heat and distilled fluid storage system. The reflector-bracket subassembly has a reflecting panel made from at least one sheet of reflective material typically flat or formed into a plurality of substantially parallel linear troughs shaped to concentrate solar radiation ideally. Also, this reflector acts as a means of further stress and strain distribution and dissipation into the structural elements of the bracket subassembly. Therefore, in this configuration the reflector will also have the structural function of a spring that share and cooperate with the other structural members in bearing the pressure loads induced inside the heat storage tank and the distillation column. The reflector-bracket subassembly also has a bracket that provides structural support for all the other components including the heat and fluid storage system.

A preferred embodiment of my solar heater-distiller also includes a composite heat and distillate storage system. The system includes a covered, insulated, cylindrical tank. The tank contains a heat storage medium, such as distilled water, and can include a phase change material to increase the density of the stored energy. The heat storage system includes a means of removal of the stored heat energy, or heat exchanger, for utilization in heating an external flow of water, such as tap water running into the hot water pipe system of a house. The longitudinal walls of the cylindrical tank are formed with a multiplicity of substantially parallel troughs or ribs that run around the tank circumference. This geometry will enhance the capability of the tank to deform elastically under pressure and therefore transmit the strain and stress generated by internal pressures to the external composite structure conformed by the insulation material and the outside cover of the heat storage system, sharing the loads in a cooperative way. This composite construction of a solar heat storage system is unique and allows for the economical use of more exotic materials such as stainless steels or high temperature plastics that are resistant to corrosion. Additionally, the ribbed construction of the tank walls decreases the formation of scale and increase heat transfer by enhancing fluid turbulence. Furthermore, the continuous expansion and contraction of the tank walls help to loosen any scale that might form so that it can be easily removed during maintenance. At the mid point of the tank's longitudinal axis, a steam intake bent pipe is placed to receive steam from the distillation column through an disconnectable universal union. The universal union is used to connect the storage tank to the distillation column for vapor and heat transfer. The steam or vapor will condense into distillate and will release latent heat inside the storage tank. The latent heat will be absorbed by the distillate inside the storage tank and transferred to the external water flow for further use.

In one preferred embodiment, the evacuated glass solar collector consists of a multiplicity of substantially parallel linear evacuated glass solar collectors. Each evacuated collector consists of an external glass vacuum envelope with circular cross section, and an internal concentric glass tube for absorbing the incident solar radiation. The internal surface of the absorbing glass tube is first sputtered with a layer of infrared radiant material and then with a layer of a selective solar radiation absorber. The glass absorbing tubes have one end closed in the vacuum and the other end with opening external to the vacuum. This open end is sealed to the glass vacuum envelope. An additional glass vacuum envelope insert is placed inside each glass absorbing tube. The various glass parts of the evacuated glass solar collector are formed from the same glass or glass with substantially the same thermal expansion. This allows much easier and much lower cost sealing of the various parts of the evacuated glass solar collector. The open end of the vacuum tube is inserted into the lateral holes of the distillation column and releasably sealed by silicon rings. The distilland will fill the vacuum tube collector and boil creating a turbulent liquid and vapor mass flow with self-cleaning characteristics that will help mitigate and slow down salt precipitation inside the distillation column subassembly.

The fouling-corrosion resistant integrated solar heater-distiller-pasteurizer of this invention is unique in its choice of features for its design, which optimize its performance while minimizing its extended cost. The unique integration, simplicity, versatility and modularity of this design lead to low initial and extended cost. The choice of design characteristics, which minimize heat loss and maximize solar energy collection and self-cleaning lead to a highly efficient solar heater-distiller-pasteurizer which can reliably operate at temperatures suitable for distillation and pasteurization processes. Further, the functional and structural integration of the composite heat storage system, the distillation column-reflector-bracket assembly, and the evacuated glass solar collector into one compact unit is very important, since this leads to the economical use of corrosion and fouling resistant materials and assembly processes at much lower cost, and a more efficient, reliable, flexible, and versatile operation.

The present invention provides an integrated, and yet simplified, solar heating-distilling-pasteurizing system of greatly improved efficiency, proven commercial feasibility, lower initial and operational costs, improved reliability, better performance in different climates, improved durability, and easier fabrication and distribution which form the essence of this invention.

### BRIEF DESCRIPTION OF THE DRAWINGS

Further objects, features, and advantages of the present invention will become apparent upon the consideration of the following detailed description of the presently-preferred embodiment when taken in conjunction with the accompanying drawing, wherein:

FIG. 1 is a perspective view of the combined solar distiller and heater system of the preferred embodiment of the present invention showing the major component parts contained thereto;

FIG. 2 is a top plan view of the combined solar distiller and heater system of the present invention showing a condenser assembly, a distillation column assembly, a plurality of glass solar (vacuum) collectors and a float valve device;

FIG. 3 is a side elevational view of the combined solar distiller and heater system of the present invention showing the condenser assembly, the distillation column assembly, the glass solar vacuum collectors and the float valve device;

FIG. 4 is a side elevational view of the combined solar distiller and heater system of the present invention showing the distillation column assembly and the glass solar vacuum collectors in an assembled configuration having a lateral angle alpha;

FIG. 5 is a cutaway perspective view of the combined solar distiller and heater system of the present invention showing a top cover section and insulation partially removed to reveal a chamber, sealing ring gaskets, baffle location, a liquid inlet-feed pipe and a vapor/liquid outlet pipe within the distillation column assembly;

FIG. 6 is a cutaway perspective view of the combined solar distiller and heater system of the present inventions showing the cover section and insulation partially removed to reveal portion s fo the glass solar vacuum collectors, a check valve, a drain valve and a chamber inlet pipe within the distillation column assembly;

FIG. 7 is a partial cross-sectional view of the combined solar distiller and heater system of the present invention taken along lines 7-7 of FIG. 5 in the direction of the arrow showing the distillation column assembly, the interior chamber and the glass solar vacuum collectors;

FIG. 8 is a front elevational view of the combined solar distiller and heater system of the present invention showing the float valve device;

FIG. 9 is a side elevational view of the combined solar distiller and heater system of the present invention showing the float valve device;

FIG. 10 is a cross-sectional view of the combined solar distiller and heater system of the present invention taken along lines 10-10 of FIG. 8 in the direction of the arrows showing an interior chamber of the float valve device;

FIG. 11 is a perspective view of the combined solar distiller and heater system of the present invention showing a reflector panel and a bracket subassembly;

FIG. 12 is a perspective view of the combined solar distiller and heater system of the present invention;

FIG. 13 is a side elevational view of the combined solar distiller and heater system of the present invention showing the condenser assembly;

FIG. 14 is a cross-sectional view of the combined solar distiller and heater system of the present invention taken along lines 14-14 of FIG. 13 in the direction of the arrow showing an interior compartment and its major component parts of the condenser assembly;

FIG. 15 is a cross-sectional view of the combines solar distiller and heater system of the present invention showing the glass solar vacuum collector having an external glass vacuum envelope member and an internal vacuum tube;

FIG. 16 is an exploded plan view of the combined solar distiller and heater system of the present invention showing the external glass vacuum envelope member and the internal glass vacuum tube;

FIG. 17 is a cross-sectional view of the combined solar distiller and heater system of the present invention taken along lines 17-17 of FIG. 15 in the direction of the arrows showing the external glass vacuum envelope member and the internal glass vacuum tube of the glass solar vacuum collector;

FIG. 18 is a cross-sectional view of the combined solar distiller and heater system of the present invention taken along lines 18-18 of FIG. 3 in the direction of the arrows showing the internal component parts of the condenser assembly; and

FIG. 19 is a sectional view of the combined solar distiller and heater system of the present invention showing the condenser assembly in an operational use for distiller use and pasteurizer use modes only.

### DETAILED DESCRIPTION OF THE PREFERRED EMBODIMENT

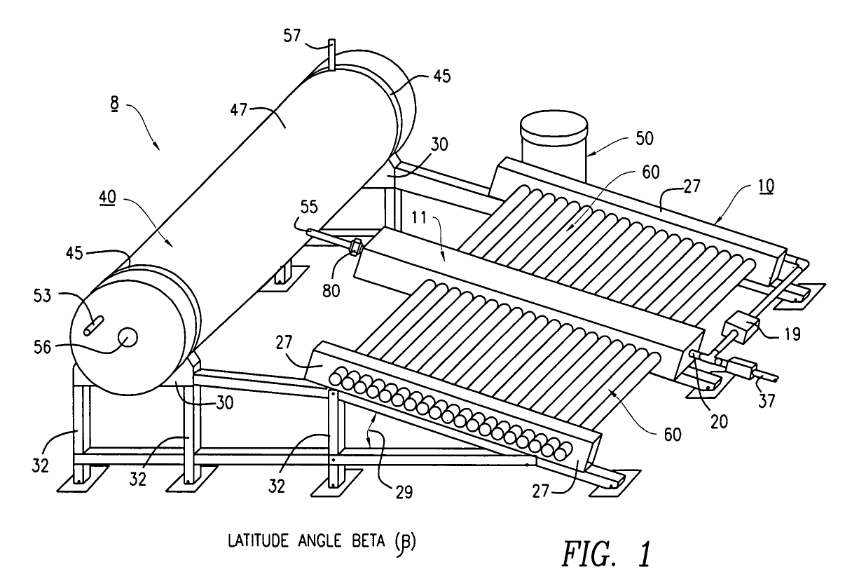

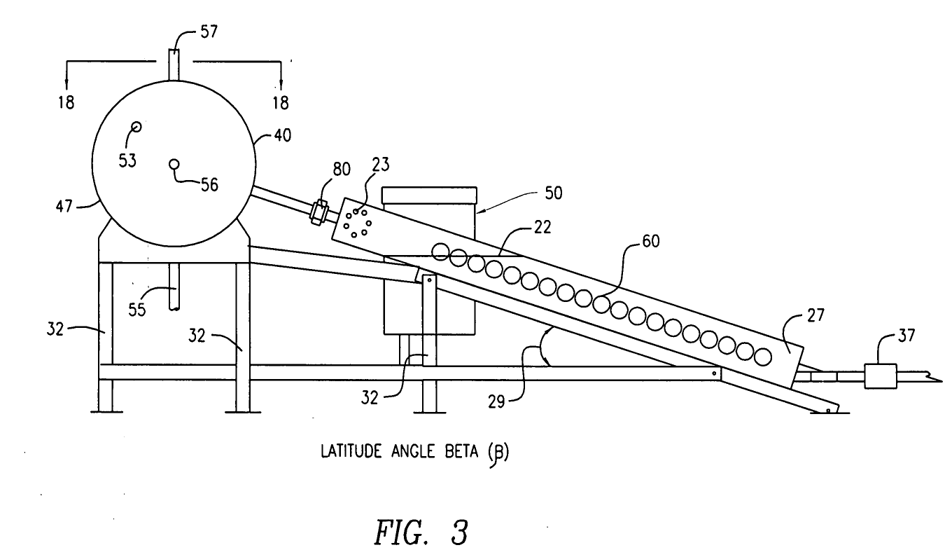

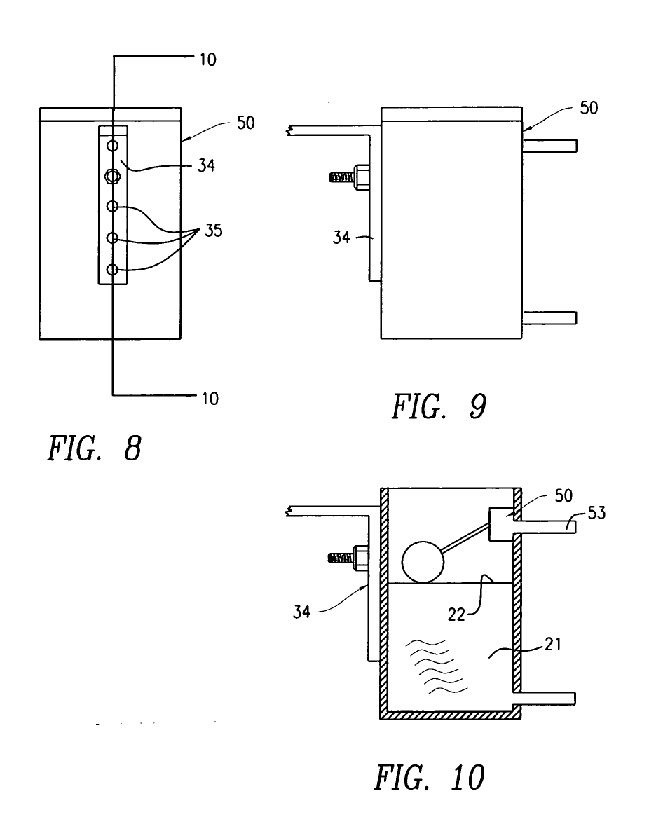

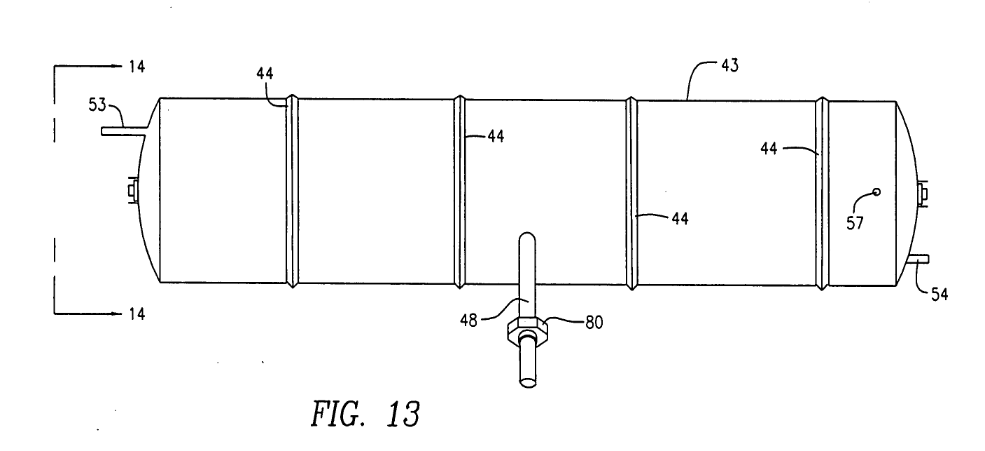

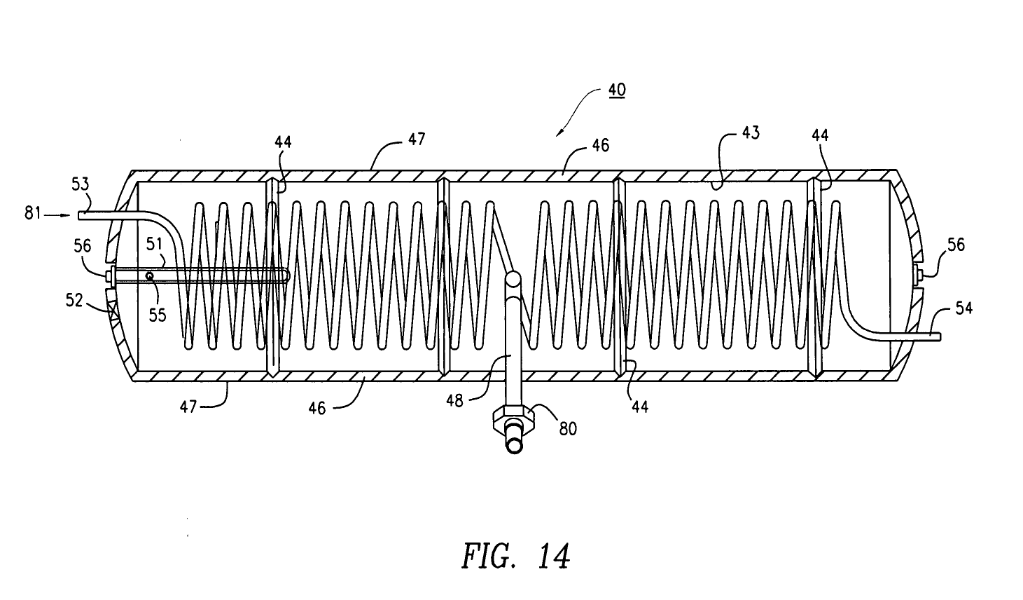

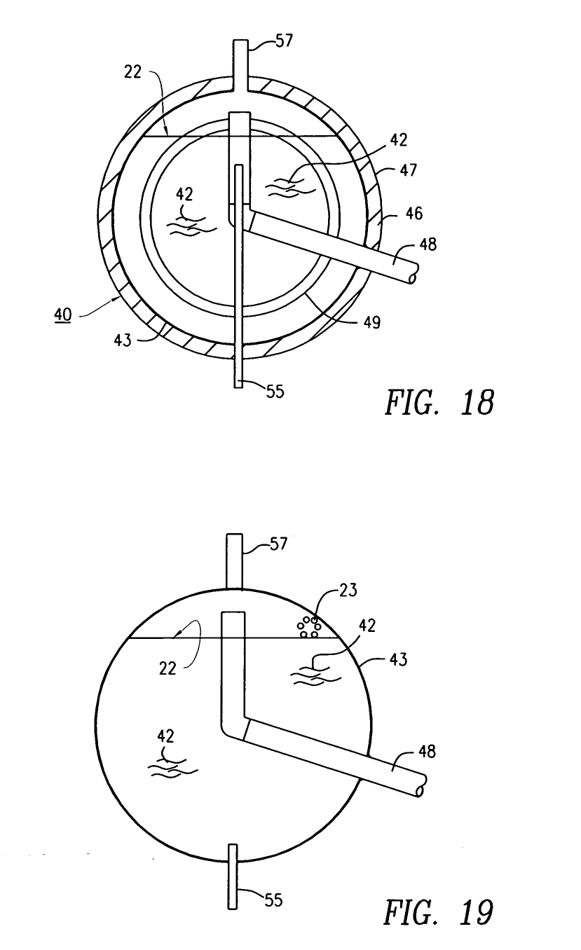

The integrated solar heater, distiller and pasteurizer system 8 and its component parts of the preferred embodiment of the present invention are represented in detail by FIGS. 1 through 19 of the patent drawings. The combined solar heater, distiller and pasteurizer system 8 is used for the heating (ΔH) of a liquid medium 21 such as water; alcoholic beverages such as wine, whiskey, rum and the like; milk and the like, in order to remove impurities, particulates and precipitates from the liquid medium 21. This system includes a distillation column-reflector-bracket assembly 10, a composite distillate and heat storage assembly 40, and at least one evacuated glass solar collector 60 having selective absorption.

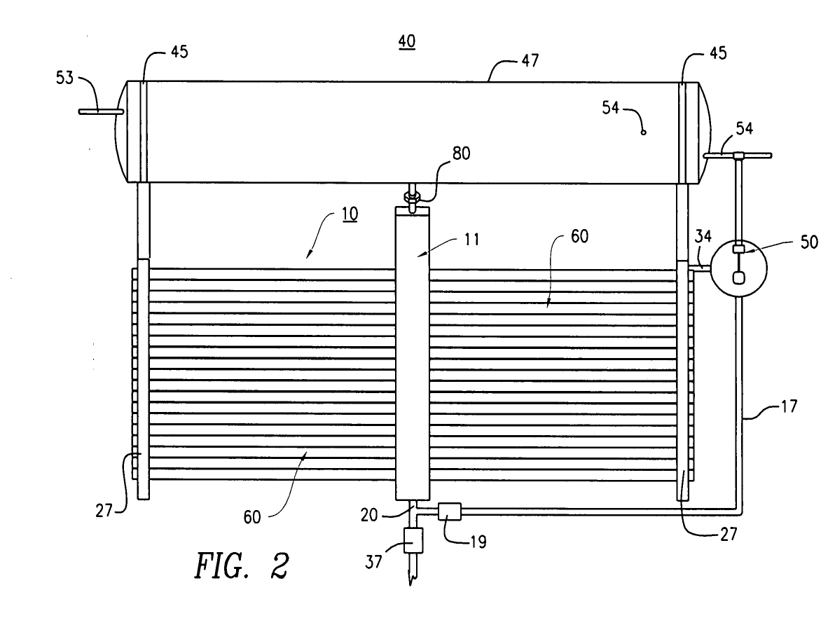

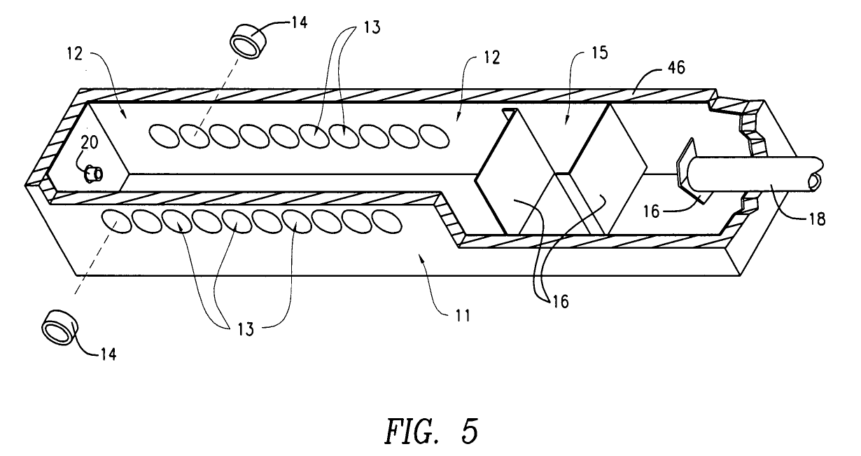

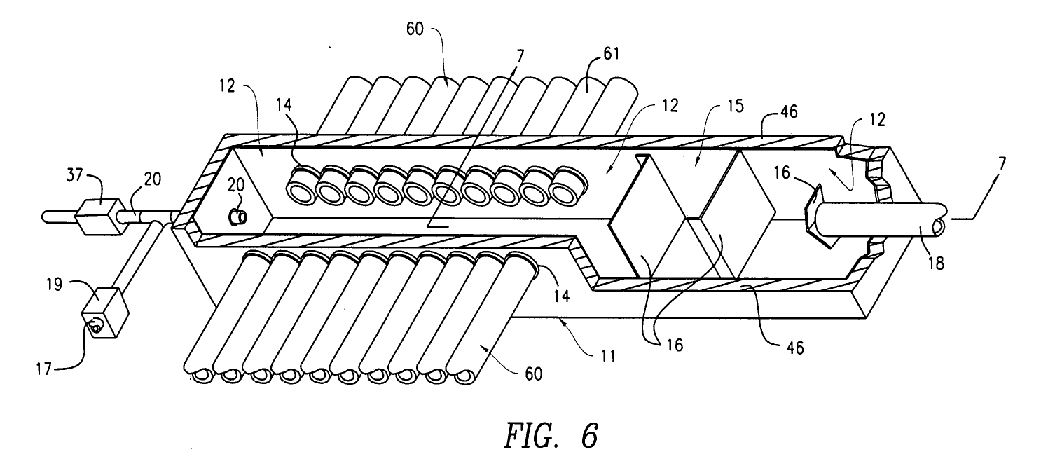

FIGS. 1 and 2 illustrates the distillation column-reflector-bracket assembly 10 that includes the distillation column subassembly 11 that is a principal part of this invention. As shown in FIGS. 5 through 7, the distillation column subassembly 11 is used for the heating of the liquid medium 21 from a liquid phase (PL) to a vapor phase (PV). FIGS. 5 and 6 illustrate the distillation column subassembly 111 which consists of an insulated and covered chamber 12, typically made of sheet stainless steel, where lateral holes 13 have been cut to accommodate evacuated glass solar collectors 60 that are slid into high temperature ring gaskets 14, typically made of silicon, that releasably seals the gap between the chamber 12 and the evacuated tubes 60. The chamber 12 is insulated with a layer of insulation 46, typically polyurethane, and covered with a protective cover plate 47, typically made of stainless steel.

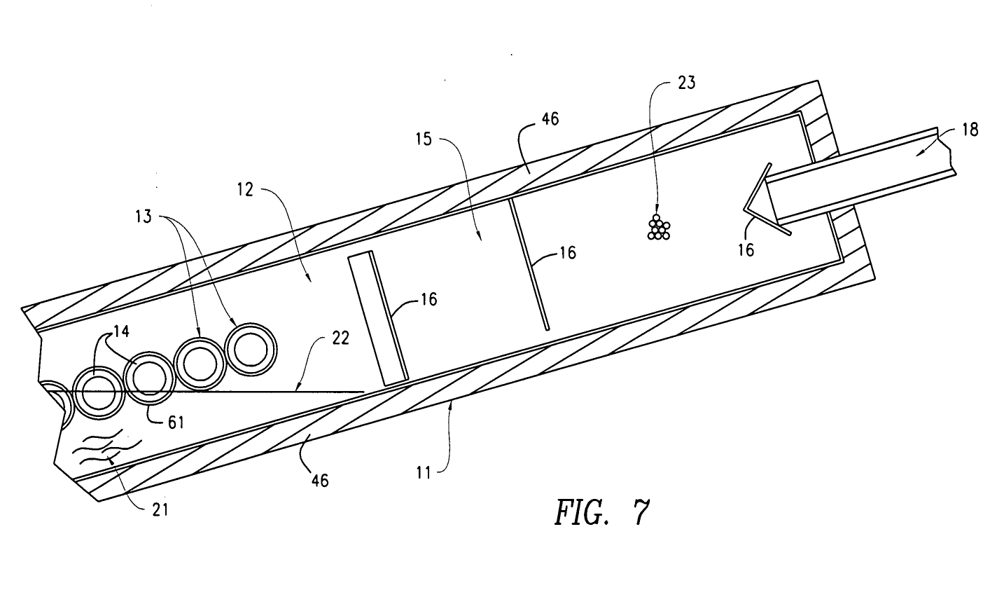

FIG. 2 illustrates a float valve mechanism 50 that supplies a liquid medium 21 to the distillation column subassembly 11 through the liquid feed pipe 17, a check valve 19, and the chamber inlet 20. The distillation column 11 is filled with the liquid medium 21 that also flows into the solar vacuum tube collectors 60 where the heating and evaporation process take place. FIG. 7 illustrates that the float valve mechanism 50 automatically maintains the correct liquid level 22 inside the distillation column subassembly 11. FIGS. 2, and 8 to 10 illustrate that the float valve mechanism 50 is attached to the frame 31 by means of an adjustable float bracket 34 that has five different vertical positions 35 with different heights where the float valve mechanism 50 can be attached. Each of the five positions corresponds to a particular operation mode of this invention.

The distillation column subassembly 111 collects and concentrates the steam or vapor 23 generated inside the attached evacuated glass solar collectors 60. The evacuated tube collectors 60 are attached to the distillation column subassembly 11 at a lateral angle 28 that will enhance the buoyancy flow of steam out of the evacuated tubes 60 and into the distillation column 11. The lateral angle beta (β) is in the range of 1° to 90°. The column subassembly 11 also may include a separation chamber 15 with baffles 16 arranged to help separate the vapor 23 from the boiling liquid medium 21 and conduct the vapor 23 through a vapor outlet 18 into the distillate and energy storage assembly 40. The column subassembly 11 may also include a drain valve 37 to discard precipitates.

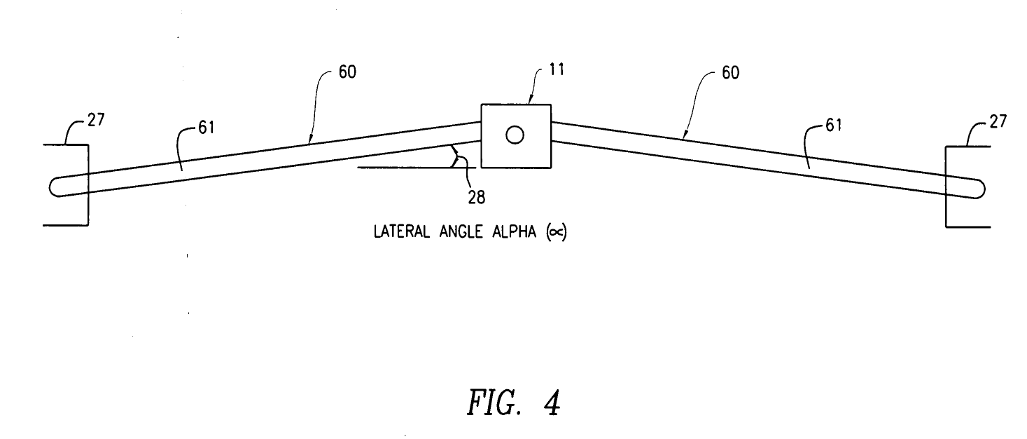

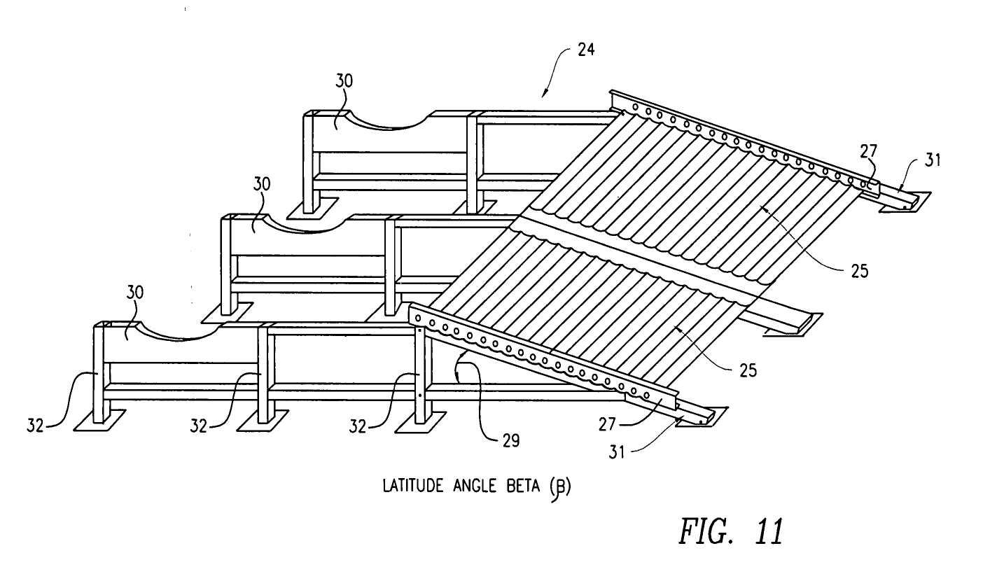

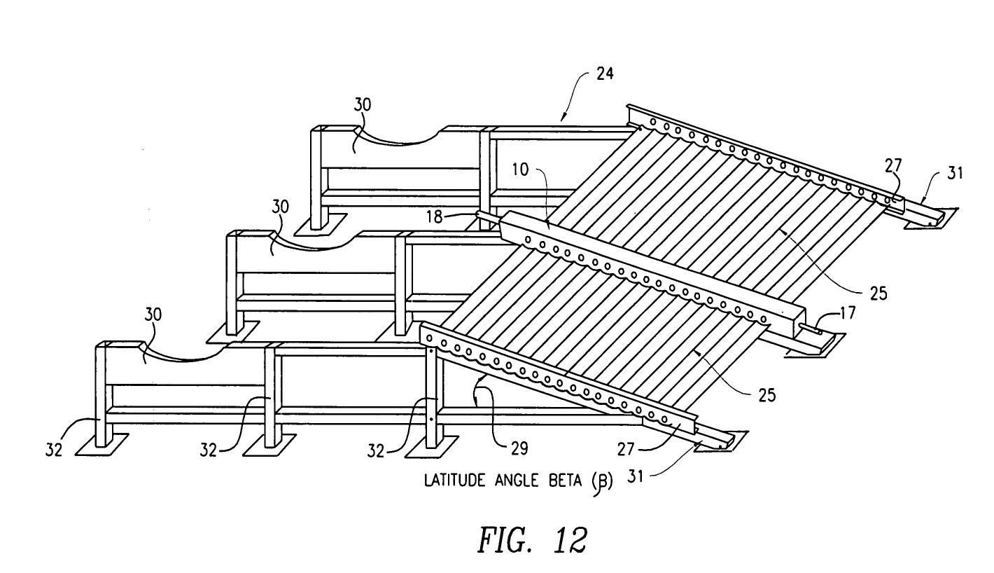

The distillation column-reflector-bracket assembly 10 also includes a reflector-bracket subassembly 24 illustrated in FIGS. 11 and 12. The reflector-bracket subassembly 24 includes a reflecting panel 25 made from at least one sheet of reflective material formed into a plurality of substantially parallel linear troughs 25 shaped to concentrate solar radiation approximately ideally. The reflector sheet is typically made of a single sheet of polished stainless steel and is riveted into the frame 31 so as to become a single structural unit. Also, this reflector acts as a means of further stress and strain distribution and dissipation into the structural elements of the bracket subassembly 24. Therefore, in this configuration the reflecting panel 25 will also have the structural function of a spring that shares and cooperates with the other structural members in bearing the pressure and thermal expansion loads induced inside the heat storage tank and the distillation column. The reflector-bracket subassembly 24 also comprises a frame 31 typically made of angle steel that provides structural support for all the other components including the distillate and heat storage assembly 40, distillation column 11, side vacuum tube supports 27, a storage bracket 30, legs 32, tensors 33, and anchor shoes 36 for anchoring the equipment on to a surface. The tensors 33 and legs 32 are typically made of angle steel and secured to the frame 31 via screws and nuts and are dimensioned in such proportions as to optimize the latitude angle 29 proper to the latitude where the system of this invention is installed. The latitude angle alpha (α) is in the range of 0° to 90°. FIG. 4 illustrates the lateral angle 28 between the evacuated solar collectors 60 and the horizon. The angle 28 is needed to facilitate the rise of vapor into the distillation column subassembly 11. The storage bracket 30 shown in FIG. 11 is typically made of stamped steel formed into a substantially round surface with a storage strap 45 shown in FIG. 1 used to secure the composite distillate and heat storage assembly 40. This surface matches and supports the distillate and heat storage assembly 40 so as to transfer part of the mechanical loads into frame 31 and the reflecting panel 25.

As will be appreciated, the modular, integrated and releasable mounting used in the present the distillation column-reflector-bracket assembly 10 lends itself to be assembled by the user and to be distributed in the form of kits to be installed by end users further reducing the total cost of the solar system of this invention. The present distillation column-reflector-bracket design is unique because of its functional and structural integrity. From a functional integration perspective it integrates the distillation, reflector, and support functions. From a structural integration point of view it shares and helps to bear the stress and strains generated by the distillate and heat storage assembly 40 and the distillation column 11.

A preferred embodiment of my solar heater-distiller also includes a composite heat and distillate storage system 40. Referring now to FIGS. 1, 11 and 12 the composite distillate and heat storage assembly 40 is mounted on the reflector-bracket subassembly 24 by means of straps 45. The system includes a covered, insulated, internal tank or bladder 43, typically of stainless steel or CPVC, and is enclosed by an insulating and stress-strain transmitting insulation layer 46, typically of polyurethane, to retain the captured solar energy, to provide freeze protection, and to distribute the stress and strain generated by internal pressure into the external protective cover plate 47 and the reflector-bracket subassembly 24. The tank contains a heat storage medium 42, such as distilled water, and can include a high-density solid or phase change material to increase the density of the stored energy. The cold liquid inlet 53, hot liquid outlet 54, overflow vent 57 and distillate outlet 55 are welded to the sidewall of the bladder 43. The storage system 40 includes a means of removal of the stored heat energy, or heat exchanger 49, for utilization in heating a relatively cool external flow of liquid, such as tap water running into the hot water pipe system of a house or industry, and to preheat liquid medium 21 before entering the float valve mechanism 50. The cold liquid inlet 53 and hot liquid outlet 54 are connected to the heat exchanger 49. The storage system 40 also includes a distillate outlet 55 as a means of removal of a distillate 42, such as distilled water, for utilization in a house or industrial process. An optional electric heating element 51, thermostat 52 and associated wiring are mounted into the bladder 43 via an access hole 56. The longitudinal walls of the cylindrical tank 41 are formed with a multiplicity of substantially parallel ribs 44 that run around the tank circumference. This geometry will enhances the capability of the tank to deform elastically under pressure and therefore transmit the strain and stress generated by internal pressures to the external composite structure conformed by the insulation material and the outside cover of the heat storage system, sharing the loads in a cooperative way. This composite construction of the distillate and heat storage system 40 is unique and allows the economical use of more exotic materials such as stainless steels or high temperature plastics that are resistant to corrosion. Additionally, the ribbed construction of the tank walls 41 decrease the formation of scale and increase heat transfer by enhancing fluid turbulence. Furthermore, the continuous expansion and contraction of the tank walls help to loosen any scale that might form so that it can be easily removed during maintenance. At the mid point of the tank's longitudinal axis, a steam intake bent pipe 48 is placed to receive steam from the distillation column 11 through a releasable universal union 80. The universal union 80 is used to connect the storage tank to the distillation column for vapor and heat transfer. The steam or vapor 23 condenses into distillate and releases latent and sensible heat inside the storage system. The latent and sensible heat will be absorbed by the heat storage medium or distillate 42 inside the storage tank 41 and later transferred by means of the heat exchanger 49 to the external liquid flow entering the cold liquid inlet 53 and exiting through the hot liquid outlet 54 for further domestic, commercial or industrial use.

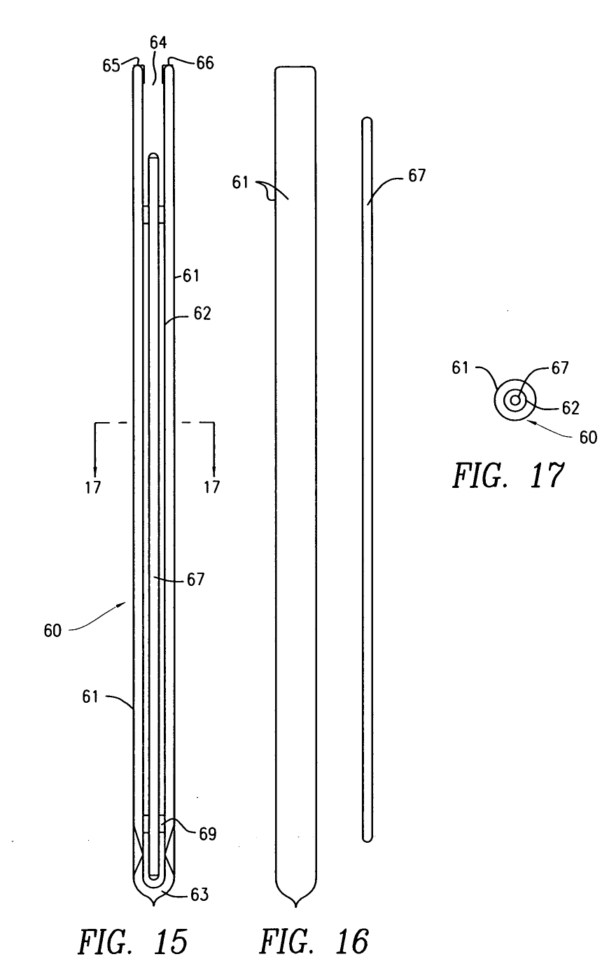

As illustrated in FIGS. 1 to 3, in one preferred embodiment, a solar collector consists of a multiplicity of substantially parallel linear evacuated all glass solar collectors 60. As illustrated by FIGS. 15, 16 and 17 each evacuated collector 60 consists of an external glass vacuum envelope 61 with a circular cross section, and an internal concentric glass tube 62 for absorbing the incident solar radiation. The external surface of the absorbing glass tube is first sputtered with layers of selective solar radiation absorbers. The all-glass absorbing tubes have one end closed in the vacuum 63 and the other end with an opening external to the vacuum 64. The open end 64 is sealed with a glass-to-glass seal 65 to the glass vacuum envelope. A metal protective insert 66 is placed at the open end 64 of the vacuum tube collector 60 to protect the collector against thermal shock. FIG. 15 illustrates an additional glass vacuum envelope insert 67 is placed inside each glass evacuated collector tube 60 to improve heat and mass transfer. The insert 67 consists of an evacuated glass envelop sealed at both ends and with its external surface sputtered with a layer of metallic material 68 such as aluminum or stainless steel. The layer will also assist in protecting the vacuum tubes from thermal shock. The insert is held at the center of each collector 60 by means of spacer springs 69 made from metal such as stainless steel. The various glass parts of the evacuated glass solar collector 60 are formed from the same glass or glass with substantially the same thermal expansion. This allows much easier and much lower cost sealing of the various parts of the evacuated glass solar collector 60. The open end 64 of the vacuum tube 60 is inserted into the lateral holes 13 of the distillation column subassembly 11 and releasably sealed by high temperature ring gaskets 14 typically made of silicon. The liquid medium or distilland 21 will fill the vacuum tube collector and boil creating a turbulent liquid and vapor mass flow with self-cleaning characteristics that will help mitigate and slow down salt precipitation inside the heater-distiller.

### Operation of the Present Invention

The solar system of this invention can be configured to operate in one of five different modes: heater-distiller, distiller only, heater only, heater-pasteurizer, and pasteurizer only. By adjusting the liquid level 22 inside the distillation column 11 any one of the five operational modes can be configured. Controlling the relative height of the float valve mechanism 50 with relationship to the distillation column 11 performs the adjustment of the liquid level 22. The float valve mechanism 50 can be moved up or down and set to any of the five preset positions 35 that the adjustable float bracket 34 has. Once the position of the float valve mechanism 50 is set, the system will operate automatically if it is connected to a liquid source that delivers the distilland or liquid to be heated. Each of the five modes of operation will be described.

Heater-Distiller Operation

The heater-distiller operation is a preferred mode of operation of this invention. A liquid source 81 containing liquid medium 21 is connected to the cold liquid inlet 53. The liquid will be preheated as it flows through the heat exchanger 49 and will fill float valve mechanism 50 until a preset level 22 is reached. The float valve mechanism 50 will be set to the proper height for the heating-distilling operation by means of adjusting float bracket 34. This setting will allow the liquid to flow into the distillation column subassembly 111 until it is filled up to the preset level 22 with the liquid medium 21 to be heated and boiled. The liquid will also flow into the evacuated glass solar collectors 60 where the heating and evaporation processes take place. The float valve mechanism 50 automatically maintains the correct liquid level 22 inside the distillation column 11 by automatically compensating for liquid evaporation. The check valve 19 will prevent liquid from returning to float valve mechanism 50 as a result of backpressure created by vapor 23. The distillation column subassembly 11 collects and concentrates the steam or vapor 23 generated inside the attached evacuated glass solar collector 60 tubes. The vapor 23 flows to the separation chamber 15 where the baffles 16 are arranged to help separate the vapor 23 from the boiling liquid medium 21 and conduct the vapor 23 into the energy and distillate storage assembly 40 via vapor outlet 18 and intake bent pipe 48. Once the vapor 23 is inside the energy and distillate storage assembly 40 it will condensate and become part of the distillate 42 thereby increasing its volume and level. During the condensation process, vapor 23 will release its latent thermal heat into the distillate 42 thereby increasing its temperature. The distillate level will continue to increase until it reaches the overflow vent 57. The distillate can be extracted from the storage assembly 40 through distillate outlet 55 and supplied to any external use such as a house or industrial process. The relatively cold liquid source 81, such as water, can enter the cold liquid inlet 53, flow through heat exchanger 49, absorb thermal energy from distillate 42, and exit at a higher temperature through hot liquid outlet 54 to be used by a house or industrial process and to maintain preset level 22 inside float valve mechanism 50 resulting in an automatic heating-distilling cycle as long as cold liquid source 81 supplies liquid to the system.

Distiller-Only Operation

The distiller-only operation is similar to the heater-distiller operation with the exception that a simplified storage assembly 58 is used. This simplified storage system is illustrated in FIG. 19 and it is very similar to the composite distillate and heat storage assembly 40 except that it has no cover plate 47, no insulation 46, and no heat exchanger 49. Therefore simplified storage 58 will not retain heat and cannot heat an external flow of liquid.

Heater-Only Operation

In the heater-only operation the float valve mechanism 50 is adjusted to it's highest position in such a manner that the distillation column subassembly 11 is completely full and the preset level 22 is set to be higher that the universal union 80 and lower than overflow vent 57. This setting substantially increases the liquid mass so that it takes much longer for the liquid medium 21 to boil. With this setting liquid medium 21 will transfer heat directly through the walls of intake bent pipe 48 into distillate 42 without any phase change. In this way the equipment becomes a high capacity solar liquid heater.

Heater-Pasteurizer Operation

The heater-pasteurizer operation is similar to the heater-only operation with the exception that preset level 22 is set slightly lower. By using this setting the liquid medium 21 will increase its volume as it is heated, raising its level inside the intake bent pipe 48 until it reaches the pasteurizing temperature at the moment that it overflows from the bent pipe 48 into the bladder 43. This way, given a sufficient amount of time, all the liquid inside the bladder will be pasteurized and most virus and bacteria will be killed.

Pasteurizer-Only Operation

The pasteurizer-only operation is similar to the heater-pasteurizer operation with the exception that a simplified storage assembly 58 is used.

Description and Operation of Alternative Embodiments:

The solar liquid heater-distiller of this invention can be modified with the addition of heat pipes, flow-through vacuum tube solar collectors, wicks, solenoid controlled valves, electronic sensors and controls, and software so that sea water can be desalinized and salt precipitates can be effectively discarded from the system. Its thermo dynamical and heat transfer operation would be essentially the same but it would also include cleaning cycles to remove precipitated salt from the system.

### CONCLUSION, RAMIFICATIONS, AND SCOPE OF INVENTION

Thus, the solar equipment of this invention provides a highly versatile, efficient, low cost device that can be used in many areas of the world. While the above description contains many specificities, these should not be construed as limitations on the scope of the invention, but rather as an exemplification of one preferred embodiment thereof. Many other variations are possible. For example, additional heat exchangers and geometrical configurations could be implemented in order to further increase the equipment efficiency. Also, the introduction of electronic controls and software can make the invention capable of handling large amounts of solid precipitates. Electronic controls can also help to implement large-scale applications of this technology by controlling multiple units connected together. The bracket assembly could be modified or eliminated so as to integrate this invention with the roof of a building. Accordingly, the scope of the invention should be determined not by the embodiments illustrated, but by the appended claims and their legal equivalents.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A combined and integrated solar heating, solar pasteurizing and solar distilling system for producing pasteurized, distilled fluid and hot fluid in a two-stage process, comprising:
a) a plurality of solar collectors all connected to a common distillation unit for heating a supply of fluid in said solar collectors to produce vapor in said distillation unit;
b) a housing having heat transfer means for receiving fluid to be heated by said vapor from said distillation unit to produce hot fluid in said heat transfer means and to produce distilled fluid within said housing, respectively; and
c) means for transferring said vapor from said distillation unit to said housing without transferring said fluid from said distillation unit to said housing to prevent contamination of said distilled fluid by said fluid.

2. A combined solar heating and solar distilling system in accordance with claim 1, further including means for controlling the amount of said fluid in said distillation unit.

3. A combined solar heating and solar distilling system in accordance with claim 2, wherein said means for controlling is a float valve mechanism which may be preset to different float positions to adjust the level of said fluid in said distillation unit.

4. A combined solar heating and solar distilling system in accordance with claim 1, wherein said heat transfer means is a coiled heat exchanger disposed within said housing.

5. A combined solar heating and solar distilling system in accordance with claim 1, wherein said means for transferring said vapor includes a separation chamber having a plurality of baffles disposed within said distillation unit.

6. A combined solar heating and solar distilling system in accordance with claim 1, wherein said distillation unit includes a reflector-bracket subassembly.

7. A combined solar heating and solar distilling system in accordance with claim 6, wherein said reflector-bracket subassembly includes a reflecting panel made from at least one sheet of reflective material formed into a plurality of substantially parallel linear channels shaped to concentrate solar radiation within each of said solar vacuum collectors.

8. A combined solar heating and solar distilling system in accordance with claim 7, wherein said reflecting panel is made from a single sheet of polished stainless steel for forming a part of a bracket subassembly.

9. A combined solar heating and solar distilling system in accordance with claim 8, wherein said bracket subassembly includes a frame having a plurality of tensors and legs detachably connected thereto, tube supports, a storage bracket and said reflecting panel being detachably connected to said frame for reducing stress and strain and dissipation thereof to the structural elements of said bracket subassembly.

10. A combined solar heating and solar distilling system in accordance with claim 1, wherein said distillation unit is disposed at a latitude angle alpha (α) for facilitating the rise of vapor within said distillation unit.

11. A combined solar heating and solar distilling system in accordance with claim 10, wherein said latitude angle alpha (α) is in the range of 0° to 90°.

12. A combined solar heating and solar distilling system in accordance with claim 1, wherein said plurality of solar collectors are disposed at a lateral angle beta (β) for facilitating the rise of vapor within said plurality of solar collectors and said distillation unit.

13. A combined solar heating and solar distilling system in accordance with claim 12, wherein said lateral angle beta (β) is in the range of 1° to 90°.

14. A combined solar heating and solar distilling system in accordance with claim 4, wherein said housing is a condenser including said coiled heat exchanger, means for cold liquid inlet and means for hot liquid outlet connected to said coiled heat exchanger, means for pressure release, means for distillate outlet, and an overflow vent.

15. A combined solar heating and solar distilling system in accordance with claim 14, wherein said condenser includes an internal tank having an insulation layer thereon.

16. A combined solar heating and solar distilling system in accordance with claim 1, wherein said plurality of solar collectors each include an external glass vacuum envelope member and an internal concentric glass tube for the selective absorption of the incident solar radiation.

17. A combined solar heating and solar distilling system in accordance with claim 1, wherein said plurality of solar collectors each include a glass evacuated envelope insert.

18. A combined solar heating and solar distilling system in accordance with claim 1, wherein said plurality of solar collectors each include a heat pipe.

19. A combined solar heating and solar distilling system in accordance with claim 1, wherein said plurality of solar collectors each include wick inserts.

20. A combined solar heating and solar distilling system in accordance with claim 2, wherein said means for controlling the amount of said fluid in said distillation unit is a programmable electronic control unit having electronic sensors connected to electronic valves being controlled by a software program for cleaning out precipitates from said distillation unit and also having a software desalinization program for purifying salt water in said distillation unit.
